(19) United States
(12) Patent Application Publication
(10) Pub. No.: US 2014/0140060 A1
(43) Pub. Date: May 22, 2014

(54) LED BULB

(71) Applicant: DIODE-ON OPTOELECTRONICS LIMITED, Taichung City (TW)

(72) Inventor: Ivan LIU, Taichung City (TW)

(73) Assignee: DIODE-ON OPTOELECTRONICS LIMITED, Taichung City (TW)

(21) Appl. No.: 13/855,050

(22) Filed: Apr. 2, 2013

(30) Foreign Application Priority Data
Nov. 16, 2012 (TW) 101222259

(51) Int. Cl. F21K 99/00

(52) U.S. Cl. CPC F21K 9/50
USPC 362/235

(57) ABSTRACT

An LED bulb includes a heat dissipating seat, a circuit board, a plurality of LEDs mounted to the circuit board, and a light reflecting unit. The heat dissipating seat includes a surrounding wall and an end wall connected to one end of the surrounding wall. The circuit board is coupled to the end wall and has a first securing unit. The light reflecting unit has a main wall and a bottom wall. The main wall extends from the circuit board, has an inner diameter gradually increasing in the direction away from the other end of the surrounding wall, and is disposed for reflecting light emitted from some of the LEDs. The bottom wall is surrounded by and connected to the main wall, and has a second securing unit fastened to the first securing unit.

### FIELD OF THE INVENTION

The invention relates to a light emitting diode (LED) bulb, more particularly to an LED bulb that has a light reflecting unit.

### DESCRIPTION OF THE RELATED ART

Lighting equipments are closely related to people's lives. Traditional light bulb products, such as incandescent bulbs, have high energy consumptions and are easily burned out.

An LED lighting device is advantageous in lower energy consumption. However, an LED has a relatively narrow illumination range of from 90 degrees to 130 degrees. Moreover, the CRI (Color Rendering Index) of the LED lighting equipment is relatively poor.

### SUMMARY OF THE INVENTION

Therefore, the object of the present invention is to provide an LED bulb that can alleviate the abovementioned drawbacks of the prior art.

Accordingly, an LED bulb of the present invention comprises a heat dissipating seat, a circuit board, a plurality of spaced-apart LEDs, and a light reflecting unit. The heat dissipating seat includes a surrounding wall that surrounds an axis and that has opposite ends along the axis, and an end wall that is connected to one of the ends of the surrounding wall. The circuit board is coupled to the end wall of the heat dissipating seat and has a first securing unit. The LEDs are mounted to the circuit board. The light reflecting unit has an annular main wall and a bottom wall. The main wall extends from the circuit board in the direction of the axis away from the other one of the ends of the surrounding wall, has an inner diameter gradually increasing in the direction away from the other one of the ends of the surrounding wall, and is disposed for reflecting light emitted from some of the LEDs. The bottom wall is surrounded by and connected to the main wall, and has a second securing unit fastened to the first securing unit of the circuit board.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of a preferred embodiment of an LED bulb according to the invention;

FIG. 2 is an exploded perspective view of the preferred embodiment;

FIG. 3 is a side view of the preferred embodiment; and

FIG. 4 is a sectional view of the preferred embodiment.

### DETAILED DESCRIPTION OF THE PREFERRED EMBODIMENT

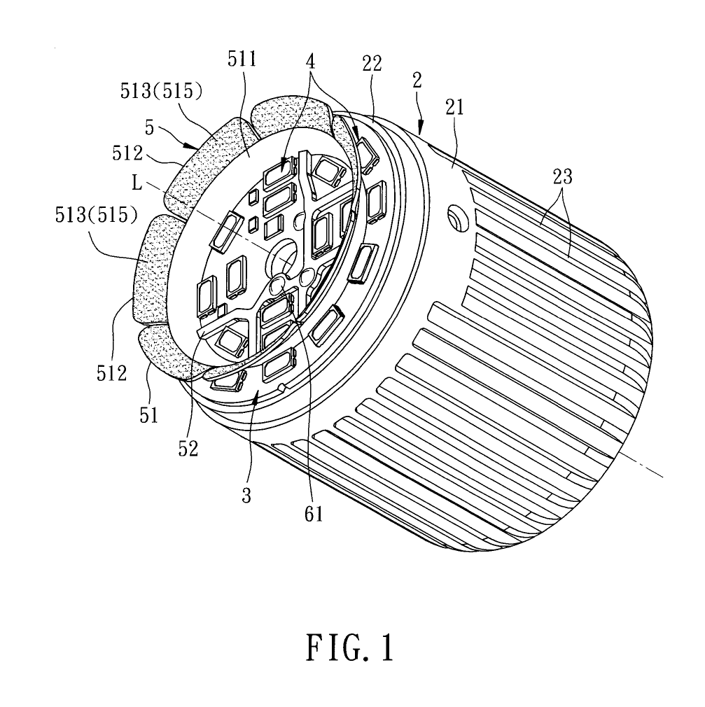

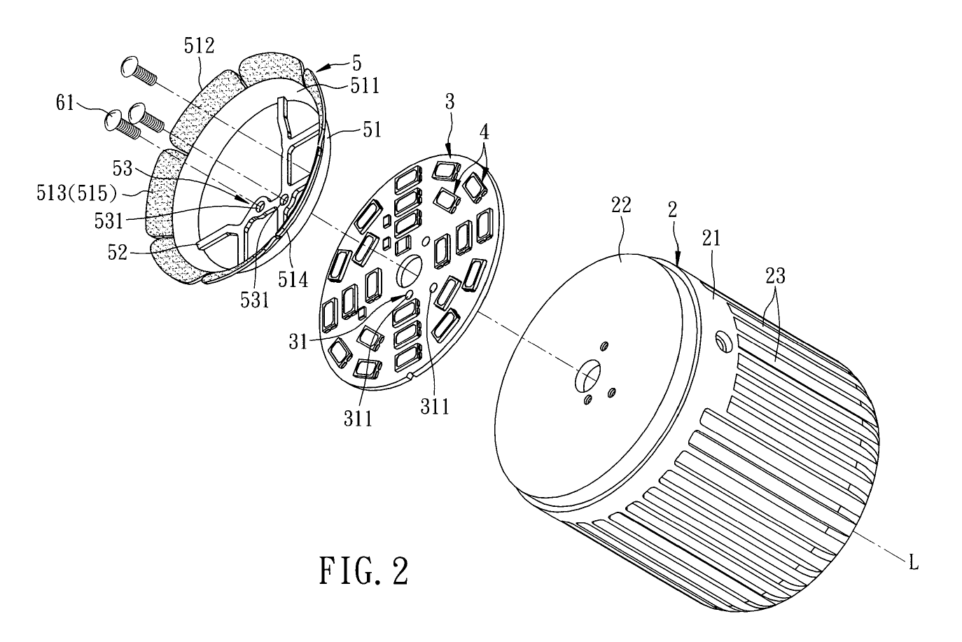

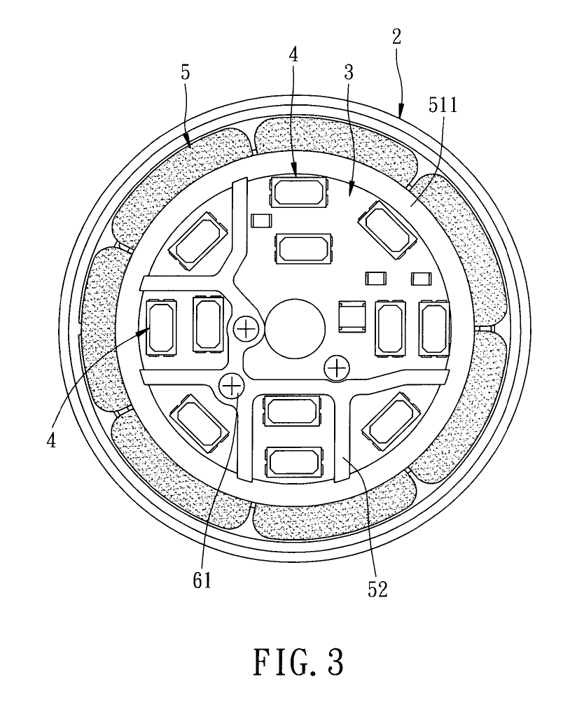

Referring to FIGS. 1 to 3, the preferred embodiment of an LED bulb according to this invention is shown to include a heat dissipating seat 2, a circuit board 3, a plurality of LEDs 4, a light reflecting unit 5 and a plurality of fasteners 61.

The heat dissipating seat 2 includes a surrounding wall 21 that surrounds an axis (L) and that has opposite ends along the axis (L), a round end wall 22 that is connected to one of the ends of the surrounding wall 21, and a plurality of heat dissipating fins 23 that are formed on the surrounding wall 21 and that are parallel to the axis (L). The heat dissipating seat 2 is made of a material having good thermal conductivity for dissipating heat generated by the LEDs 4.

The circuit board 3 is round and is coupled to the end wall 22 of the heat dissipating seat 2. The circuit board 3 has a first securing unit 31. In this embodiment, the first securing unit 31 is in the form of a plurality of positioning holes 311 formed in the circuit board 3.

The LEDs 4 are mounted to the circuit board 3 and are spaced-apart from one another. In this embodiment, the LEDs 4 are arranged in a radiating manner with respect to the axis (L).

The light reflecting unit 5 has an annular main wall 51 that extends from the circuit board 3 in the direction of the axis (L) away from the other one of the ends of the surrounding wall 21, and that has an inner diameter gradually increasing in the direction away from the other one of the ends of the surrounding wall 21. The light reflecting unit 5 further has a bottom wall 52 that is surrounded by and connected to the main wall 51, and that has a second securing unit 53 fastened to the first securing unit 31 of the circuit board 3. In this embodiment, some of the LEDs 4 are disposed within the enclosure of the main wall 51, and the remaining of the LEDs 4 are disposed outside of the main wall 51.

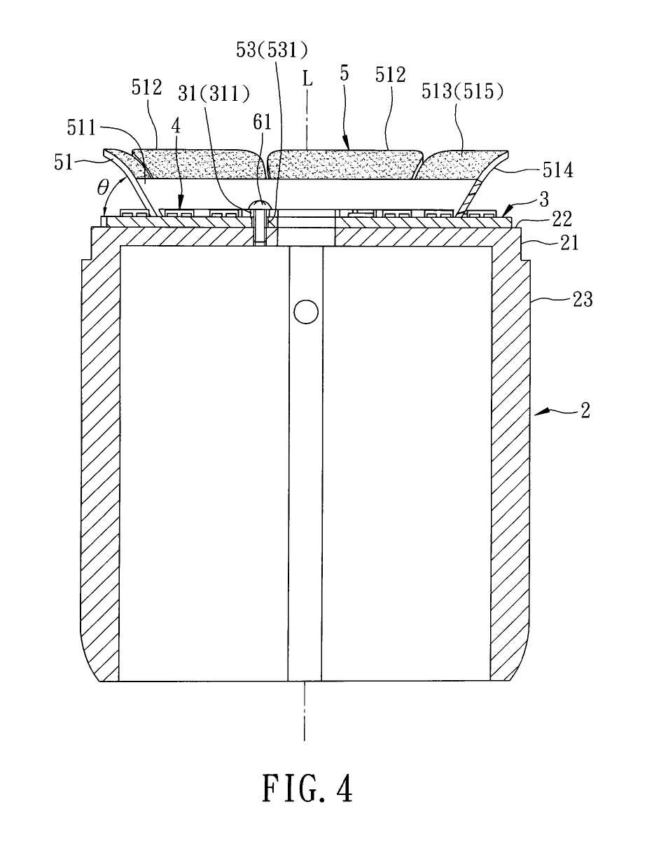

Referring further to FIG. 4, the main wall 51 of the light reflecting unit 5 has an annular wall segment 511 connected to the circuit board 3 and forming an angle (θ) with the circuit board 3 that ranges between 20 to 90 degrees, and a plurality of angularly spaced-apart petal-shaped wall segments 512 extending from the annular wall segment 511. Preferably, in this embodiment, the angle (θ) is configured to be 60 degrees.

Each of the petal-shaped wall segments 512 of the light reflecting unit 5 has an inner surface 513 confronting the axis (L), and an outer surface 514 opposite to the inner surface 513. The inner surface 513 of each of the petal-shaped wall segments 512 is covered with a colored coating 515. In this embodiment, the colored coating 515 on the inner surface 513 of each of the petal-shaped wall segments 512 is a red colored coating. The outer surface 514 of each of the petal-shaped wall segments 512 and each of inner and outer surfaces of the annular wall segment 511 is covered with a white colored coating or a mirror layer. The provision of the red colored coating 515 is used to increase the CRI of the LED bulb of this invention so as to reproduce the colors of an object illuminated by the LED bulb more faithfully as with natural light source than the prior art. In practice, the colored coating 515 may as well be other colored coatings in accordance with the user's demand. In this embodiment, the main wall 51 includes seven equiangularly spaced-apart petal-shaped wall segments 512.

The second securing unit 53 has a plurality of through holes 531 formed in the bottom wall 52 and registered respectively with the positioning holes 311 that are formed in the circuit board 3.

Each of the fasteners 61 is configured as a bolt extending removably and threadedly through a respective one of the positioning holes 311 and a corresponding one of the through holes 531 for fastening the light reflecting unit 5 to the circuit board 3.

From the foregoing, the LED bulb of this invention has the following advantages:

1. By virtue of the configuration of the main wall 51 of the light reflecting unit 5, light emitted from the LEDs 4 that are disposed within the main wall 51 is to be reflected by the main wall 51 to form a light source having a diverging illumination angle, which is similar to a conventional incandescent bulb.

2. The colored coating 515 on the pedal-shaped wall segments 512 effectively increases the CRI of the LED bulb of this invention.

3. Through the first securing unit 31 and the second securing unit 53, the light reflecting unit 5 can be easily fixed to the circuit board 3.

4. The light emitted from the LEDs 4 would be reflected by and would pass through the light reflecting unit 5, and would evenly illuminate the illumination area of the LED bulb.

It should be noted that, the first securing unit 31 and the second securing unit 53 may be configured to be coupled in a tongue-and-groove manner in other embodiment of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An LED bulb comprising:
a heat dissipating seat including a surrounding wall that surrounds an axis and that has opposite ends along the axis, and an end wall that is connected to one of said ends of said surrounding wall;
a circuit board coupled to said end wall of said heat dissipating seat and having a first securing unit;
a plurality of spaced-apart light emitting diodes mounted to said circuit board; and
a light reflecting unit having
an annular main wall that extends from said circuit board in the direction of the axis away from the other one of said ends of said surrounding wall, that has an inner diameter gradually increasing in the direction away from the other one of said ends of said surrounding wall, and that is disposed for reflecting light emitted from some of said light emitting diodes, and
a bottom wall that is surrounded by and connected to said main wall, and that has a second securing unit fastened to said first securing unit of said circuit board.

2. The LED bulb as claimed in claim 1, wherein said some of said light emitting diodes are disposed within an enclosure of said main wall of said light reflecting unit, and the remaining of said light emitting diodes are disposed outside of said main wall.

3. The LED bulb as claimed in claim 1, wherein said main wall of said light reflecting unit has an annular wall segment connected to said circuit board and forming an angle with said circuit board that ranges between 20 to 90 degrees, and a plurality of angularly spaced-apart petal-shaped wall segments extending from said annular wall segment away from said circuit board.

4. The LED bulb as claimed in claim 3, wherein each of said petal-shaped wall segments of said light reflecting unit has an inner surface confronting the axis and covered with a colored coating.

5. The LED bulb as claimed in claim 3, wherein said main wall of said light reflecting unit includes seven petal-shaped wall segments.

6. The LED bulb as claimed in claim 1, wherein:
said first securing unit is in the form of a plurality of positioning holes formed in said circuit board;
said second securing unit has a plurality of through holes formed in said bottom wall and registered respectively with said positioning holes; and
said light bulb further comprises a plurality of fasteners, each of which extends through a respective one of said positioning holes and a corresponding one of said through holes for fastening said light reflecting unit to said circuit board.

7. The LED bulb as claimed in claim 6, wherein each of said fasteners engages threadedly the respective one of said positioning holes and the corresponding one of said through holes.
